(19) United States
(12) Patent Application Publication
(10) Pub. No.: US 2015/0172702 A1
(43) Pub. Date: Jun. 18, 2015

(54) FRACTIONAL-PEL INTERPOLATION FILTER METHOD, FILTER DEVICE AND ELECTRONIC DEVICE USING THE SAME

(71) Applicant: PEKING UNIVERSITY SHENZHEN GRADUATE SCHOOL, Shenzhen (CN)

(72) Inventors: Ronggang WANG, Shenzhen (CN); Hao LV, Shenzhen (CN); Zhenyu WANG, Shenzhen (CN); Shengfu DONG, Shenzhen (CN); Wen GAO, Shenzhen (CN)

(21) Appl. No.: 14/636,162

(22) Filed: Mar. 2, 2015

Related U.S. Application Data
(63) Continuation-in-part of application No. PCT/CN2013/082789, filed on Sep. 2, 2013.

(30) Foreign Application Priority Data
Sep. 3, 2012 (CN) 201210321179.1

(51) Int. Cl. H04N 19/523; H04N 19/86; H04N 19/615

(52) U.S. Cl. CPC H04N 19/523; H04N 19/615; H04N 19/86

(57) ABSTRACT

A fractional-pel interpolation filter method. The method adopts an 8-tap interpolation filter and a 6-tap interpolation filter, and includes: 1) applying an 8-tap interpolation filter to adjacent integer-pel pixels, thus acquiring fractional-pel pixels between adjacent integer-pel pixels in a horizontal direction or a vertical direction; and 2) to the adjacent fractional-pel pixels between the adjacent integer-pel pixels, applying the horizontal 8-tap interpolation filter in the horizontal direction and then a 6-tap interpolation filter in the vertical direction for conducting interpolations twice, thus acquiring the remaining 9 fractional-pel pixels.

### CROSS-REFERENCE TO RELATED APPLICATIONS

This application is a continuation-in-part of International Patent Application No. PCT/CN2013/082789 with an international filing date of Sep. 2, 2013, designating the United States, now pending, and further claims priority benefits to Chinese Patent Application No. 201210321179.1 filed Sep. 3, 2012. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND OF THE INVENTION

1. Field of the Invention

The invention relates to a fractional-pel interpolation filter method, a filter device using the same, and an electronic device using the same.

2. Description of the Related Art

The fractional-pel interpolation technology is adapted to improve the accuracy of the motion prediction in the video codec technology. The fractional-pel interpolation technology has been used in MPEG-1 for the first time but is limited in the 1/2-pel motion estimation, and the accuracy and the performance thereof are not good enough. The interpolation accuracy is increased to a 1/4-pel since MPEG-4ASP. A 6-tap or a 4-tap filter is adopted by H.264/AVC or AVS Jizhun Profile to acquire a 1/2-pel and then to derive a 1/4-pel using an average filter. The high efficiency video coding (HEVC) adopts a DCT-based interpolation filter for improving the interpolation performance; however, the complexity of the interpolation calculation is relatively high.

### SUMMARY OF THE INVENTION

In view of the above-described problems, it is one objective of the invention to provide a fractional-pel interpolation filter method, a filter device using the same, and an electronic device using the same.

To achieve the above objective, in accordance with one embodiment of the invention, there is provided a fractional-pel interpolation filter method. The method adopts an 8-tap interpolation filter and a 6-tap interpolation filter and comprises:

1) applying an 8-tap interpolation filter to adjacent integer-pel pixels, whereby acquiring fractional-pel pixels between adjacent integer-pel pixels in a horizontal direction or a vertical direction; and

2) to the adjacent fractional-pel pixels between the adjacent integer-pel pixels, applying the horizontal 8-tap interpolation filter in the horizontal direction and then a 6-tap interpolation filter in the vertical direction for conducting interpolations twice, whereby acquiring remaining 9 fractional-pel pixels.

In a class of this embodiment, interpolated coefficients of the 8-tap interpolation filter are as follows: a coefficient corresponding to a 1/4-pel is {−1, 4, −10, 57, 18, −6, 3, −1}; a coefficient corresponding to a 1/2-pel is {−1, 4, −11, 40, 40, −11, 4, −1}; and a coefficient corresponding to a 3/4-pel is {−1, 3, −6, 18, 57, −10, 4, −1}.

In a class of this embodiment, interpolated coefficients of the 6-tap interpolation filter are as follows: a coefficient corresponding to the 1/4-pel is {2, −9, 57, 17, −4, 1}; a coefficient corresponding to the 1/2-pel is {2, −9, 39, 39, −9, 2}; and a coefficient corresponding to the 3/4-pel is {1, −4, 17, 57, −9, 2}.

In a class of this embodiment, interpolation processes of fractional-pel pixels a_{0,0}, b_{0,0} and c_{0,0} are as follows: performing interpolation filtering on the adjacent integer-pel pixels in the horizontal direction using the 8-tap interpolation filter, and adopting the filter coefficients corresponding to 1/4-pel, 2/4-pel, and 3/4-pel positions to acquire corresponding fractional-pel pixels a_{0,0}, b_{0,0}, and c_{0,0}; and calculation equations are as follows:

a_{0,0}=(−A_{-3,0}+4×A_{-2,0}−10×A_{-1,0}+57×A_{0,0}+18×A_{1,0}−6×A_{2,0}+3×A_{3,0}−A_{4,0})>>shift1

b_{0,0}=(−A_{-3,0}+4×A_{-2,0}−11×A_{-1,0}+40×A_{0,0}+40×A_{1,0}−11×A_{2,0}+4×A_{3,0}−A_{4,0})>>shift1

c_{0,0}=(−A_{-3,0}+3×A_{-2,0}−6×A_{-1,0}+18×A_{0,0}+57×A_{1,0}−10×A_{2,0}+4×A_{3,0}−A_{4,0})>>shift1

In a class of this embodiment, interpolation processes of the fractional-pel pixels d_{0,0}, h_{0,0}, and n_{0,0} are as follows: performing interpolation filtering on the adjacent integer-pel pixels in the vertical direction using the 8-tap interpolation filter, and adopting the filter coefficients corresponding to 1/4-pel, 2/4-pel, and 3/4-pel positions to acquire corresponding fractional-pel pixels d_{0,0}, h_{0,0}, and n_{0,0}; and calculation equations are as follows:

d_{0,0}=(−A_{0,-3}+4×A_{0,-2}−10×A_{0,-1}+57×A_{0,0}+18×A_{0,1}−6×A_{0,2}+3×A_{0,3}−A_{0,4})>>shift1

h_{0,0}=(−A_{-0,-3}+4×A_{0,-2}−11×A_{0,-1}+40×A_{0,0}+40×A_{0,3}−11×A_{0,2}+4×A_{0,3}−A_{0,4})>>shift1

n_{0,0}=(−A_{0,-3}+3×A_{0,-2}−6×A_{0,-1}+18×A_{0,0}+57×A_{0,1}−10×A_{0,2}+4×A_{0,3}−A_{0,4})>>shift1

In a class of this embodiment, interpolation processes of the fractional-pel pixels e_{0,0}, i_{0,0}, and p_{0,0} are as follows: using the 8-tap interpolation filter on the adjacent integer-pel pixels in the horizontal direction, and using the interpolation filter coefficient corresponding to the 1/4-pel position, whereby acquiring an intermediate value a′_{0,i} (i ranges from between −3 and 4); using the 6-tap interpolation filter on the intermediate value a′_{0,i} in the vertical direction, and using the interpolation filter coefficients corresponding to 1/4-pel, 2/4-pel, and 3/4-pel positions, respectively, whereby acquiring corresponding fractional-pel pixels e_{0,0}, i_{0,0}, and p_{0,0}; and calculation equations are as follows:

e_{0,0}=(2×a′_{0,-2}−9×a′_{0,-1}+57×a′_{0,0}+17×a′_{0,1}−4×a′_{0,2}+a′_{0,3})>>shift2

i_{0,0}=(2×a′_{0,-2}−9×a′_{0,-1}+39×a′_{0,0}+39×a′_{0,1}−9×a′_{0,2}+2×a′_{0,3})>>shift2

p_{0,0}=(a′_{0,-2}−4×a′_{0,-1}+17×a′_{0,0}+57×a′_{0,1}−9×a′_{0,2}+2×a′_{0,3})>>shift2

In a class of this embodiment, interpolation processes of the fractional-pel pixels f_{0,0}, j_{0,0}, and q_{0,0} are as follows: using the 8-tap interpolation filter on the adjacent integer-pel pixels in the horizontal direction, and using the interpolation filter coefficient corresponding to the 2/4-pel position, whereby acquiring an intermediate value b′_{0,i} (i ranges from between −3 and 4); using the 6-tap interpolation filter on the intermediate value b′_{0,i} in the vertical direction, and using the interpolation filter coefficients corresponding to 1/4-pel, 2/4-pel, and 3/4-pel positions, respectively, whereby acquiring corresponding fractional-pel pixels f_{0,0}, j_{0,0} and q_{0,0}; and calculation equations are as follows:

f_{0,0}=(2×b′_{0,-2}−9×b′_{0,-1}+57×b′_{0,0}+17×b′_{0,1}−4×b′_{0,2}+b′_{0,3})>>shift2

j_{0,0}=(2×b′_{0,-2}−9×b′_{0,-1}+39×b′_{0,0}+39×b′_{0,1}−9×b′_{0,2}+2×b′_{0,3})>>shift2

q_{0,0}=(b′_{0,-2}−4×b′_{0,-1}+17×b′_{0,0}+57×b′_{0,1}−9×b′_{0,2}+2×b′_{0,3})>>shift2

In a class of this embodiment, interpolation processes of the fractional-pel pixels g_{0,0}, k_{0,0} and r_{0,0} are as follows: using the 8-tap interpolation filter on the adjacent integer-pel pixels in the horizontal direction, and using the interpolation filter coefficient corresponding to the 3/4-pel position, whereby acquiring an intermediate value c′_{0,i} ranges from between −3 and 4); using the 6-tap interpolation filter on the intermediate value c′_{0,i} in the vertical direction, and using the interpolation filter coefficients corresponding to 1/4-pel, 2/4-pel, and 3/4-pel positions, respectively, whereby acquiring corresponding fractional-pel pixels g_{0,0}, k_{0,0} and r_{0,0}; and calculation equations are as follows:

g_{0,0}=(2×c′_{0,-2}−9×c′_{0,-1}+57×c′_{0,0}+17×c′_{0,1}−4×c′_{0,2}+c′_{0,3})>>shift2

k_{0,0}=(2×c′_{0,-2}−9×c′_{0,-1}+39×c′_{0,0}+39×c′_{0,1}−9×c′_{0,2}+2×c′_{0,3})>>shift2

r_{0,0}=(c′_{0,-2}−4×c′_{0,-1}+17×c′_{0,0}+57×c′_{0,1}−9×c′_{0,2}+2×c′_{0,3})>>shift2

In a class of this embodiment, shift1 equals 6.

In a class of this embodiment, shift2 equals 12.

In accordance with another embodiment of the invention, there is provided a fractional-pel interpolation filter device using the above method for achieving video image processing.

In accordance with another embodiment of the invention, there is provided an electronic data carrier stored with a computer program comprising the above method.

In accordance with another embodiment of the invention, there is provided an electronic device using the above method for processing a video image.

Advantages according to embodiments of the invention are summarized as follows:

The fractional-pel interpolation filter method of the invention adopts a combination of the 8-tap interpolation filter and the 6-tap interpolation filter and utilizes motion changes of a general scene which is dominant in the horizontal motions and sub-dominant in the vertical motions. Considering the calculation complexity of the 10-tap interpolation filter and the relatively poor performance of the 4-tap interpolation filter, the method of the invention adopts the filter means in the form of “8+6” for the purpose of decreasing the complexity while not obviously affecting the performance thereof.

The calculation complexity of the interpolation method of the invention is slightly higher than that of the 4-tap filter and is much lower than the 10-tap filter, but the performance of the interpolation method of the invention is comparable with that of the 10-tap filter.

The interpolation filter method of the invention optimizes the filter coefficients and adopts the filter coefficients with the best performance.

Specifically, compared with luma interpolation of the HEVC, BD-rates Y, U, and V of the invention increase only 0.7%, 0.2%, and 0.3%, but the calculation complexity of the interpolation method of the invention is lower than that of the HEVC by 10% (reductions in numbers of pixel accesses, multiplications, and additions are 9.07%, 6.42%, and 9.36%, respectively). Thus, the interpolation method of the invention is advantageous in its low complexity while keeping the performance equivalent to that of the luma interpolation of the HEVC.

### BRIEF DESCRIPTION OF THE DRAWINGS

The invention is described hereinbelow with reference to the accompanying drawings, in which:

FIG. 1 is a schematic diagram showing an interpolation method according to one embodiment of the invention; and

FIG. 2 illustrates a process for actual interpolation according to one embodiment of the invention.

### DETAILED DESCRIPTION OF THE EMBODIMENTS

For further illustrating the invention, experiments detailing a fractional-pel interpolation filter method, a filter device using the same, and an electronic device using the same are described below. It should be noted that the following examples are intended to describe and not to limit the invention.

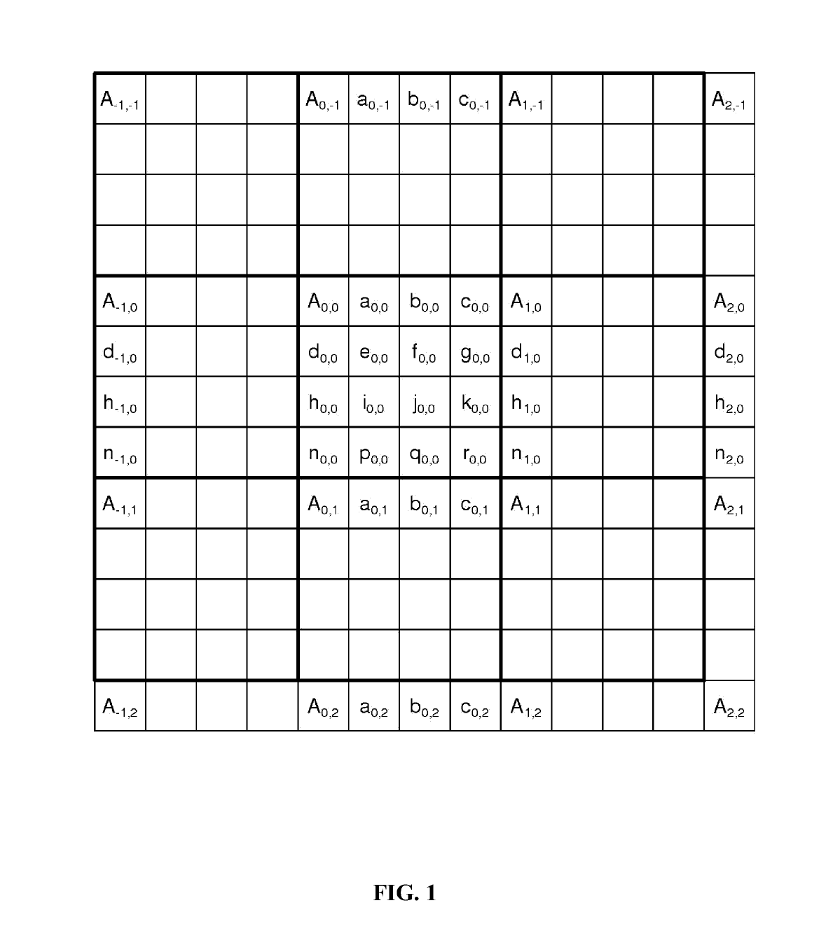

A fractional-pel interpolation filter device having low complexity adopts the following fractional-pel interpolation filter method. The interpolation process is shown in FIG. 1 in which positions, such as A_{0,0}, A_{0,1}, A_{1,0}, and A_{1,1} represented by upper-case letters are known, positions represented by the lower-case letters are fractional-pel pixels required to be acquired by interpolation. Interpolation filter is conducted using an 8-tap interpolation filter on adjacent integer-pel pixels A_{0,0} and A_{1,0} in a horizontal direction so that fractional-pel pixels a_{0,0}, b_{0,0}, and c_{0,0} are obtained; and interpolation filter is conducted using the 8-tap interpolation filter on adjacent integer-pel pixels A_{0,0} and A_{0,1} in a vertical direction so that fractional-pel pixels d_{0,0}, h_{0,0}, and n_{0,0} are obtained. For the remaining fractional-pel pixels, interpolation filter is performed on the adjacent integer-pel pixels in the horizontal direction using the 8-tap interpolation filter so as to obtain intermediate values, and interpolation filter is then conducted on the intermediate values using a 6-tap interpolation filter in the vertical direction. Coefficients of the 6-tap interpolation filter and the 8-tap interpolation filter are listed in Tables 1-2.

Acquisition of optimized coefficients in Tables 1-2 includes: trying to conduct +/−1 (plus/minus 1) on a part of the coefficients, and selecting the optimized coefficient pursuant to the experiment results. The reason for the coefficients add/minus 1 is that the coefficients obtained according to the algorithm are decimals, generally the decimals are enlarged by 64 folds, i.e., 6 bit is used to represent one coefficient, but a sum of all the coefficients should be 64 (normalization). When each coefficient is enlarged by 64 folds, factors like the intermediate values or rounding-off method are intervened, for example, a certain coefficient multiply 64 equals 17.51, then performances are tested using 17 or 18 to know which coefficient is better.

TABLE 1
Coefficients of 8-tap interpolation filter

| Fractional-pel positions | Filter coefficients | Mults | Adds |
|---|---|---|---|
| 1/4 | {−1, 4, −10, 57, 18, −6, 3, −1} | 6 | 7 |
| 2/4 | {−1, 4, −11, 40, 40, −11, 4, −1} | 6 | 7 |
| 3/4 | {−1, 3, −6, 18, 57, −10, 4, −1} | 6 | 7 |

TABLE 2
Coefficients of 6-tap interpolation filter

| Fractional-pel positions | Filter coefficients | Mults | Adds |
|---|---|---|---|
| 1/4 | {2, −9, 57, 17, −4, 1} | 5 | 5 |
| 2/4 | {2, −9, 39, 39, −9, 2} | 6 | 5 |
| 3/4 | {1, −4, 17, 57, −9, 2} | 5 | 5 |

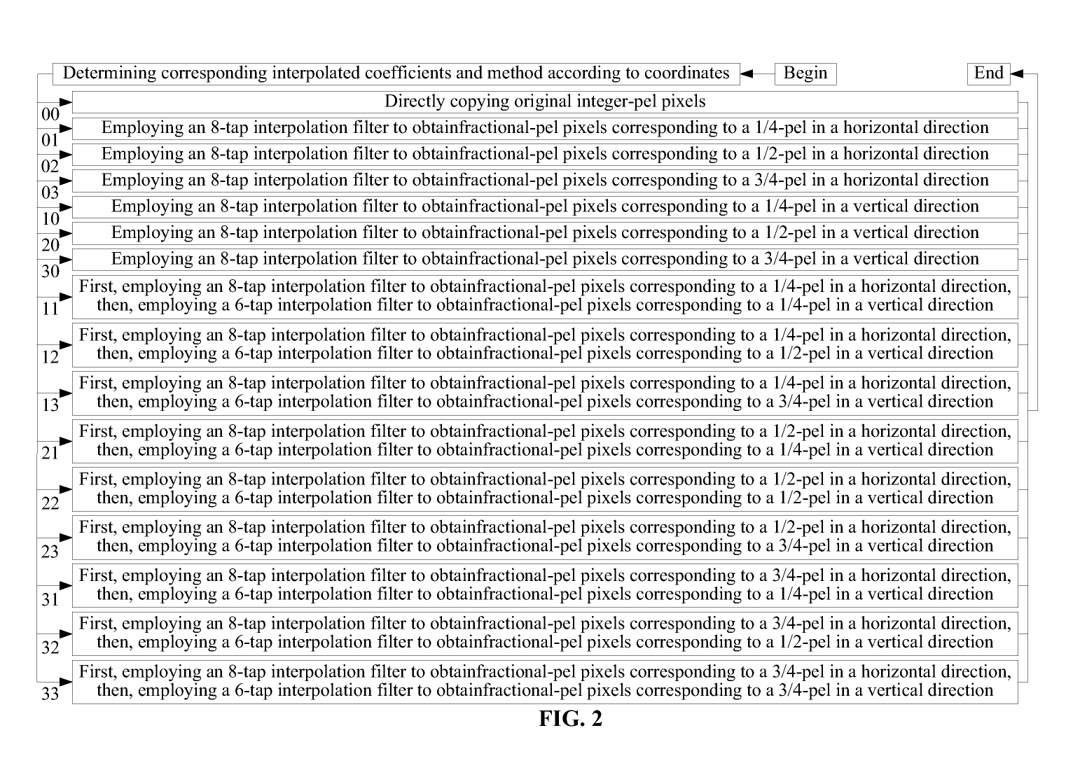

In this example, the fractional-pel interpolation filter is realized by the process shown in FIG. 2.

First step, as listed in Table 3, the fractional-pel pixels required to be interpolated is judged according to an x-axis and a y-axis.

TABLE 3
Relation between fractional-pel pixels and coordinate position

| | | | | | | | | | | | | | | | | |
|---|---|---|---|---|---|---|---|---|---|---|---|---|---|---|---|---|
| X-axis | 0 | 0 | 0 | 0 | 1 | 1 | 1 | 1 | 2 | 2 | 2 | 2 | 3 | 3 | 3 | 3 |
| Y-axis | 0 | 1 | 2 | 3 | 0 | 1 | 2 | 3 | 0 | 1 | 2 | 3 | 0 | 1 | 2 | 3 |
| Fractional -pel | A | d | h | h | a | e | i | p | b | f | j | q | c | g | k | r |

Step 2, from the judgment of the above step, corresponding fractional-pel interpolation processes are conducted as follows: for the fractional-pel a, it is only required to conduct the 8-tap interpolation filter in the horizontal direction and adopt the filter coefficient corresponding to the 1/4-pel position; and for the fractional-pel e, the 8-tap interpolation filter is conducted in the horizontal direction, and the filter coefficient corresponding to the 1/4-pel position is adopted, and then the 6-tap interpolation filter is conducted in the vertical direction, and the filter coefficient corresponding to the 1/4-pel position is adopted. Specifically, the interpolation processes of each pixel are as follows:

1) Interpolation of fractional-pel pixels a_{0,0}, b_{0,0}, and c_{0,0}: interpolation filter is performed on adjacent integer-pel pixels in the horizontal direction using the 8-tap interpolation filter, and filter coefficients corresponding to 1/4, 2/4, and 3/4-pel positions are adopted, respectively, to calculate the fractional-pel pixels a_{0,0}, b_{0,0}, and c_{0,0} using the following calculation equations:

a_{0,0}=(−A_{-3,0}+4×A_{-2,0}−10×A_{-1,0}+57×A_{0,0}+18×A_{1,0}−6×A_{2,0}+3×A_{3,0}−A_{4,0})>>shift1

b_{0,0}=(−A_{-3,0}+4×A_{-2,0}−11×A_{-1,0}+40×A_{0,0}+40×A_{1,0}−11×A_{2,0}+4×A_{3,0}−A_{4,0})>>shift1

c_{0,0}=(−A_{-3,0}+3×A_{-2,0}−6×A_{-1,0}+18×A_{0,0}+57×A_{1,0}−10×A_{2,0}+4×A_{3,0}−A_{4,0})>>shift1

2) Interpolation of fractional-pel pixels d_{0,0}, h_{0,0}, and n_{0,0}: interpolation filter is performed on adjacent integer-pel pixels in the vertical direction using the 8-tap interpolation filter, and filter coefficients corresponding to 1/4, 2/4, and 3/4-pel positions are adopted, respectively, to calculate the fractional-pel pixels d_{0,0}, h_{0,0}, and n_{0,0} using the following calculation equations:

d_{0,0}=(−A_{0,-3}+4×A_{0,-2}−10×A_{0,-1}+57×A_{0,0}+18×A_{0,1}−6×A_{0,2}+3×A_{0,3}−A_{0,4})>>shift1

h_{0,0}=(−A_{-0,-3}+4×A_{0,-2}−11×A_{0,-1}+40×A_{0,0}+40×A_{0,1}−11×A_{0,2}+4×A_{0,3}−A_{0,4})>>shift1

n_{0,0}=(−A_{0,-3}+3×A_{0,-2}−6×A_{0,-1}+18×A_{0,0}+57×A_{0,1}−10×A_{0,2}+4×A_{0,3}−A_{0,4})>>shift1

3) Interpolation of fractional-pel pixels e_{0,0}, i_{0,0}, and p_{0,0}: interpolation filter is conducted on the adjacent integer-pel pixels in the horizontal direction using the 8-tap interpolation filter, and filter coefficients corresponding to the 1/4-pel position is used, so that an intermediate value a′_{0,i} is obtained, where i ranges from between −3 and 4. a′_{0,i} is different from a′_{0,i} in that the acquisition of a′_{0,i} does not contain the final shifting function shift1. Specifically, a′_{0,0} can be derived from a_{0,0}, likewise, other intermediate values a′_{0,i} can be derived from a_{0,i}, that is, the intermediate value a_{0,1} can be derived from a_{0,1}, the intermediate value a′_{0,2} can be derived from a_{0,2}, and the intermediate value a′_{0,3} can be derived from a_{0,3}. b′_{0,i} and c′_{0,i} can be obtained likewise.

After that, interpolation filter is conducted on the intermediate value a′_{0,i} in the vertical direction using the 6-tap interpolation filter, and filter coefficients corresponding to the 1/4-pel, 2/4-pel, and 3/4-pel positions are adopted, respectively, to calculate the corresponding fractional-pel pixels e_{0,0}, i_{0,0}, and p_{0,0} using the following calculation equations:

e_{0,0}=(2×a′_{0,-2}−9×a′_{0,-1}+57×a′_{0,0}+17×a′_{0,1}−4×a′_{0,2}+a′_{0,3})>>shift2

i_{0,0}=(2×a′_{0,-2}−9×a′_{0,-1}+39×a′_{0,0}+39×a′_{0,1}−9×a′_{0,2}+2×a′_{0,3})>>shift2

p_{0,0}=(a′_{0,-2}−4×a′_{0,-1}+17×a′_{0,0}+57×a′_{0,1}−9×a′_{0,2}+2×a′_{0,3})>>shift2

4) Interpolation of fractional-pel pixels f_{0,0}, j_{0,0}, and q_{0,0}: interpolation filter is conducted on the adjacent integer-pel pixels in the horizontal direction using the 8-tap interpolation filter, and filter coefficients corresponding to the 2/4-pel position is used, so that the intermediate value b_{0,i} is obtained, where i ranges from between −3 and 4. Thereafter, interpolation filter is conducted on the intermediate value b_{0,i} in the vertical direction using the 6-tap interpolation filter, and filter coefficients corresponding to the 1/4-pel, 2/4-pel, and 3/4-pel positions are adopted, respectively, to calculate the corresponding fractional-pel pixels f_{0,0}, j_{0,0}, and q_{0,0} using the following calculation equations:

f_{0,0}=(2×b′_{0,-2}−9×b′_{0,-1}+57×b′_{0,0}+17×b′_{0,1}−4×b′_{0,2}+b′_{0,3})>>shift2

j_{0,0}=(2×b′_{0,-2}−9×b′_{0,-1}+39×b′_{0,0}+39×b′_{0,1}−9×b′_{0,2}+2×b′_{0,3})>>shift2

q_{0,0}=(b′_{0,-2}−4×b′_{0,-1}+17×b′_{0,0}+57×b′_{0,1}−9×b′_{0,2}+2×b′_{0,3})>>shift2

Interpolation of fractional-pel pixels g_{0,0}, k_{0,0}, and r_{0,0}: interpolation filter is conducted on the adjacent integer-pel pixels in the horizontal direction using the 8-tap interpolation filter, and filter coefficients corresponding to the 3/4-pel position is used, so that the intermediate value c′_{0,i} is obtained, where i ranges from between −3 and 4. Then, interpolation filter is performed on the intermediate value c′_{0,i} in the vertical direction using the 6-tap interpolation filter, and filter coefficients corresponding to the 1/4-pa, 2/4-pel, and 3/4-pel positions are adopted, respectively, to calculate the corresponding fractional-pel pixels g_{0,0}, k_{0,0}, and r_{0,0} using the following calculation equations:

g_{0,0}=(2×c′_{0,-2}−9×c′_{0,-1}+57×c′_{0,0}+17×c′_{0,1}−4×c′_{0,2}+c′_{0,3})>>shift2

k_{0,0}=(2×c′_{0,-2}−9×c′_{0,-1}+39×c′_{0,0}+39×c′_{0,1}−9×c′_{0,2}+2×c′_{0,3})>>shift2

r_{0,0}=(c′_{0,-2}−4×c′_{0,-1}+17×c′_{0,0}+57×c′_{0,1}−9×c′_{0,2}+2×c′_{0,3})>>shift2

In the above equations, shift1=6, shift2=12. Principle for selecting the value of shift is that the final result is ensured at a size of a pixel, i.e., 8 bits. For example, to interpolate one pel, the horizontal interpolation is firstly conducted (by multiplying each coefficient of the horizontal interpolation filter and a sum of all coefficients equals 64) so as to magnify the pel for 64 folds, which is equivalent to move to the left for 6 bits; then the longitudinal interpolation is conducted, and likewise, the pixel is moved to the left for another 6 bits, thus, it is required to move for 6+6=12 bits to the right to recover the original size of one pixel. In conditions of only one interpolation process is adopted, it is only required to move to the right for 6 bits at last; and if two interpolation processes are adopted, it is required to move for 12 bits.

Thus, all the 15 fractional-pel pixels are obtained from interpolations, and the steps of this example is accomplished.

The method of the invention ensures interpolation with relatively high performance as well as decrease of the calculation complexity during the interpolation.

1) Compared with luma interpolation of the HEVC, BD-rates Y, U, and V of the invention increase only 0.7%, 0.2%, and 0.3%, as listed in Table 4. However, the calculation complexity of the interpolation method of the invention, as listed in Table 5, is lower than that of the HEVC by 10% (specifically, reductions in numbers of pixel accesses, multiplications, and additions are 9.07%, 6.42%, and 9.36%, respectively). Thus, the interpolation method of the invention is advantageous in its low complexity while keeping the performance equivalent to that of the luma interpolation of the HEVC.

TABLE 4
Comparison of BD-rates between interpolation method
of present invention and luma interpolation of HEVC

BD-rates increase (%)

| Resolution | Test sequence | Y | U | V |
|---|---|---|---|---|
| 412 × 240 | Basketball Pass | 0.2 | −0.3 | −0.2 |
| | BQ Square | 2.2 | 1.2 | 1.4 |
| | Blowing Bubbles | 0.3 | 0.2 | 0.2 |
| | Race Horses | 0.2 | −0.5 | −0.3 |
| | Average | 0.7 | 0.2 | 0.3 |

TABLE 5
Comparison of calculation complexity between interpolation
method of present invention and luma interpolation of HEVC

| | Present invention | | | HEVC | | |
|---|---|---|---|---|---|---|
| | Pixel | Operations | | Pixel | Operations | |
| Fractional-pel | accesses | Mults | Adds | accesses | Mults | Adds |
| A | 1 | 0 | 0 | 1 | 0 | 0 |
| a | 8 | 6 | 7 | 7 | 5 | 6 |
| b | 8 | 6 | 7 | 8 | 6 | 7 |
| c | 8 | 6 | 7 | 7 | 5 | 6 |
| d | 8 | 6 | 7 | 7 | 5 | 6 |
| e | 8*6 | 6*6 + 5 | 7*6 + 5 | 7*7 | 5*7 + 5 | 6*7 + 6 |
| f | 8*6 | 6*6 + 5 | 7*6 + 5 | 7*8 | 6*7 + 5 | 7*7 + 6 |
| g | 8*6 | 6*6 + 5 | 7*6 + 5 | 7*7 | 5*7 + 5 | 6*7 + 6 |
| h | 8 | 6 | 7 | 8 | 8 | 7 |
| i | 8*6 | 6*6 + 6 | 7*6 + 5 | 8*7 | 5*8 + 6 | 6*8 + 7 |
| j | 8*6 | 6*6 + 6 | 7*6 + 5 | 8*8 | 6*8 + 6 | 7*8 + 7 |
| k | 8*6 | 6*6 + 6 | 7*6 + 5 | 8*7 | 5*8 + 6 | 6*8 + 7 |
| n | 8 | 6 | 7 | 7 | 7 | 6 |
| p | 8*6 | 6*6 + 5 | 7*6 + 5 | 7*7 | 5*7 + 5 | 6*7 + 6 |
| q | 8*6 | 6*6 + 5 | 7*6 + 5 | 7*8 | 6*7 + 5 | 7*7 + 6 |
| r | 8*6 | 6*6 + 5 | 7*6 + 5 | 7*7 | 7*7 + 5 | 6*7 + 6 |
| avg | 30.06 | 25.50 | 29.06 | 33.06 | 27.25 | 32.06 |

2) interpolation method of this example is compared with the interpolation processes adopting 4-tap or 10-tap interpolation filters in aspects including number of the reference pixels, number of additions adopted, and number of multiplications adopted, and specific comparisons in different aspects are as follows:

TABLE 6
4-tap filter coefficient

| Positions | Filter coefficients | Mults | Adds |
|---|---|---|---|
| 1/4 | {−6, 56, 15, −1} | 3 | 3 |
| 2/4 | {−4, 36, 36, −4} | 4 | 3 |
| 3/4 | {−1, 15, 56, −6} | 3 | 3 |

TABLE 7
10-tap filter coefficient

| Positions | Filter coefficients | Mults | Adds |
|---|---|---|---|
| 1/4 | {1, −2, 4, −10, 57, 19, −7, 3, −1, 0} | 7 | 8 |
| 2/4 | {1, −2, 5, −12, 40, 40, −12, 5, −2, 1} | 8 | 9 |
| 3/4 | {0, −1, 3, −7, 19, 57, −10, 4, −2, 1} | 7 | 8 |

It is known from the following Tables 8-9 that the calculation complexity of the interpolation method of the invention is slightly higher than that of the 4-tap filter and is much lower than the 10-tap filter, but the performance of the interpolation method of the invention is comparable with that of the 10-tap filter.

TABLE 8
Maximum number of pixel access

| | | | Present |
|---|---|---|---|
| | 4-tap | 10-tap | invention |
| | (L + 3) × | (L + 9) × | (L + 7) × |
| Max | (W + 3) | (W + 9) | (W + 7) |
| W = 4, L = 4 | 49 | 169 | 121 |
| W = 8, L = 8 | 121 | 289 | 225 |
| W = 16, L = 16 | 361 | 625 | 529 |
| W = 32, L = 32 | 1225 | 1681 | 1521 |
| W = 64, L = 64 | 4489 | 5329 | 5041 |

TABLE 9
Multiplications

| | Mults(×W × L) | | |
|---|---|---|---|
| | | | Present |
| Pel | 4-Tap | 10-Tap | invention |
| A | 0 | 0 | 0 |
| a | 3 | 7 | 6 |
| b | 4 | 8 | 6 |
| c | 3 | 7 | 6 |
| d | 3 | 7 | 6 |
| e | 3 × 4 + 3 | 7 × 10 + 7 | 6 × 6 + 5 |
| f | 4 × 4 + 3 | 8 × 10 + 7 | 6 × 6 + 5 |
| g | 3 × 4 + 3 | 7 × 10 + 7 | 6 × 6 + 5 |
| h | 4 | 8 | 6 |
| i | 3 × 4 + 4 | 7 × 10 + 8 | 6 × 6 + 6 |
| j | 4 × 4 + 4 | 8 × 10 + 8 | 6 × 6 + 6 |
| k | 3 × 4 + 4 | 7 × 10 + 8 | 6 × 6 + 6 |
| n | 3 | 7 | 6 |
| p | 3 × 4 + 3 | 7 × 10 + 7 | 6 × 6 + 5 |
| q | 4 × 4 + 3 | 8 × 10 + 7 | 6 × 6 + 5 |
| r | 3 × 4 + 3 | 7 × 10 + 7 | 6 × 6 + 5 |
| avg | 10.625 | 48.125 | 25.50 |

TABLE 10
Additions

| | Adds(×W × L) | | |
|---|---|---|---|
| | | | Present |
| Pel | 4-Tap | 10-Tap | invention |
| A | 0 | 0 | 0 |
| a | 3 | 8 | 7 |
| b | 3 | 9 | 7 |
| c | 3 | 8 | 7 |
| d | 3 | 8 | 7 |
| e | 3 × 4 + 3 | 8 × 10 + 8 | 7 × 6 + 5 |
| f | 3 × 4 + 3 | 9 × 10 + 8 | 7 × 6 + 5 |
| g | 3 × 4 + 3 | 8 × 10 + 8 | 7 × 6 + 5 |
| h | 3 | 7 | 7 |
| i | 3 × 4 + 3 | 8 × 10 + 9 | 7 × 6 + 5 |
| j | 3 × 4 + 3 | 9 × 10 + 9 | 7 × 6 + 5 |
| k | 3 × 4 + 3 | 8 × 10 + 9 | 7 × 6 + 5 |
| n | 3 | 7 | 7 |
| p | 3 × 4 + 3 | 8 × 10 + 8 | 7 × 6 + 5 |
| q | 3 × 4 + 3 | 9 × 10 + 8 | 7 × 6 + 5 |
| r | 3 × 4 + 3 | 8 × 10 + 8 | 7 × 6 + 5 |
| avg | 9.5625 | 54.5 | 29.0625 |

3) Comparisons between interpolation of the 4-tap interpolation filter and the luma interpolation of the HEVC are made, and performance of the 4-tap interpolation filter is listed in Table 11, in which BD-rates of Y, U, and V are increased by 5.6%, 3.6%, and 3.6%.

TABLE 11

BD-rates increase (%)

| Resolution | Test sequence | Y | U | V |
|---|---|---|---|---|
| 412 × 240 | BasketballPass | 0.6 | −0.4 | −0.1 |
| | BQSquare | 15.8 | 12.3 | 11.3 |
| | BlowingBubbles | 4.6 | 2.5 | 2.6 |
| | RaceHorses | 1.3 | 0.1 | 0.4 |
| | Average | 5.6 | 3.6 | 3.6 |

4) Comparisons between interpolation of the 10-tap interpolation filter and the luma interpolation of the HEVC are made, and performance of the 10-tap interpolation filter is listed in Table 12, in which BD-rates of Y, U, and V are increased by 5.6%, 3.6%, and 3.6%.

TABLE 12

BD-rates increase (%)

| Resolution | Test sequence | Y | U | V |
|---|---|---|---|---|
| 412 × 240 | BasketballPass | 0.1 | −0.2 | −0.1 |
| | BQSquare | 2.4 | 1.5 | 1.6 |
| | BlowingBubbles | 0.3 | 0.0 | −0.1 |
| | RaceHorses | 0.2 | −0.1 | 0.1 |
| | Average | 0.8 | 0.3 | 0.4 |

### Example 2

Persons skilled in the art should understand that the whole or parts of the steps in the method described in the above example can be accomplished by related hardware instructed by computer programs. A computer readable electronic data carrier is further provided. The electronic data carrier comprises but is not limited to an optical disk, a flash disk, and a hard disk. The electronic data carrier is stored with computer program for achieving the fractional-pel interpolation filter with the low complexity in Example 1.

### Example 3

An electronic device comprises a program for performing the fractional-pel interpolation method having low complexity disclosed in Example 1. The video image can be processed by starting such program. Specifically, by interpolation on the integer-pel pixels of the video image, the fractional-pel pixels are obtained. Or, the electronic device adopts the fractional-pel interpolation method of Example 1 to process the video image.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A fractional-pel interpolation filter method, comprising:
1) employing an 8-tap interpolation filter and a 6-tap interpolation filter;
2) applying the 8-tap interpolation filter to adjacent integer-pel pixels, whereby acquiring fractional-pel pixels between adjacent integer-pel pixels in a horizontal direction or a vertical direction; and
3) to the adjacent fractional-pel pixels between the adjacent integer-pel pixels, applying the horizontal 8-tap interpolation filter in the horizontal direction and then the 6-tap interpolation filter in the vertical direction for conducting interpolations twice, whereby acquiring remaining 9 fractional-pel pixels.
wherein
interpolated coefficients of the 8-tap interpolation filter are as follows:
a coefficient corresponding to a 1/4-pel is {−1, 4, −10, 57, 18, −6, 3, −1};
a coefficient corresponding to a 1/2-pel is {−1, 4, −11, 40, 40, −11, 4, −1}; and
a coefficient corresponding to a 3/4-pel is {−1, 3, −6, 18, 57, −10, 4, −1};
interpolated coefficients of the 6-tap interpolation filter are as follows:
a coefficient corresponding to the 1/4-pel is {2, −9, 57, 17, −4, 1};
a coefficient corresponding to the 1/2-pel is {2, −9, 39, 39, −9, 2}; and
a coefficient corresponding to the 3/4-pel is {1, −4, 17, 57, −9, 2}.

2. The method of claim 1, wherein
interpolation processes of fractional-pel pixels a_{0,0}, b_{0,0}, and c_{0,0} are as follows: performing interpolation filtering on the adjacent integer-pel pixels in the horizontal direction using the 8-tap interpolation filter, and adopting the filter coefficients corresponding to 1/4-pel, 2/4-pel, and 3/4-pel positions to acquire corresponding fractional-pel pixels a_{0,0}, b_{0,0}, and c_{0,0}; and calculation equations are as follows:
a_{0,0}=(−A_{-3,0}+4×A_{-2,0}−10×A_{-1,0}+57×A_{0,0}+18×A_{1,0}−6×A_{2,0}+3×A_{3,0}−A_{4,0})>>shift1
b_{0,0}=(−A_{-3,0}+4×A_{-2,0}−11×A_{-1,0}+40×A_{0,0}+40×A_{1,0}−11×A_{2,0}+4×A_{3,0}−A_{4,0})>>shift1
c_{0,0}=(−A_{-3,0}+3×A_{-2,0}−6×A_{-1,0}+18×A_{0,0}+57×A_{1,0}−10×A_{2,0}+4×A_{3,0}−A_{4,0})>>shift1

3. The method of claim 1, wherein
interpolation processes of the fractional-pel pixels d_{0,0}, h_{0,0}, and n_{0,0} are as follows: performing interpolation filtering on the adjacent integer-pel pixels in the vertical direction using the 8-tap interpolation filter, and adopting the filter coefficients corresponding to 1/4-pel, 2/4-pel, and 3/4-pel positions to acquire corresponding fractional-pel pixels d_{0,0}, h_{0,0}, and n_{0,0}; and calculation equations are as follows:
d_{0,0}=(−A_{0,-3}+4×A_{0,-2}−10×A_{0,-1}+57×A_{0,0}+18×A_{0,1}−6×A_{0,2}+3×A_{0,3}−A_{0,4})>>shift1
h_{0,0}=(−A_{-0,-3}+4×A_{0,-2}−11×A_{0,-1}+40×A_{0,0}+40×A_{0,3}−11×A_{0,2}+4×A_{0,3}−A_{0,4})>>shift1
n_{0,0}=(−A_{0,-3}+3×A_{0,-2}−6×A_{0,-1}+18×A_{0,0}+57×A_{0,1}−10×A_{0,2}+4×A_{0,3}−A_{0,4})>>shift1

4. The method of claim 1, wherein interpolation processes of the fractional-pel pixels e_{0,0}, i_{0,0}, and p_{0,0} are as follows: using the 8-tap interpolation filter on the adjacent integer-pel pixels in the horizontal direction, and using the interpolation filter coefficient corresponding to the 1/4-pel position, whereby acquiring an intermediate value a′_{0,i} (i ranges from between −3 and 4); using the 6-tap interpolation filter on the intermediate value a′_{0,i} in the vertical direction, and using the interpolation filter coefficients corresponding to 1/4-pel, 2/4-pel, and 3/4-pel positions, respectively, whereby acquiring corresponding fractional-pel pixels e_{0,0}, i_{0,0}, and p_{0,0}; and calculation equations are as follows:
e_{0,0}=(2×a′_{0,-2}−9×a′_{0,-1}+57×a′_{0,0}+17×a′_{0,1}−4×a′_{0,2}+a′_{0,3})>>shift2
i_{0,0}=(2×a′_{0,-2}−9×a′_{0,-1}+39×a′_{0,0}+39×a′_{0,1}−9×a′_{0,2}+2×a′_{0,3})>>shift2
p_{0,0}=(a′_{0,-2}−4×a′_{0,-1}+17×a′_{0,0}+57×a′_{0,1}−9×a′_{0,2}+2×a′_{0,3})>>shift2

5. The method of claim 1, wherein
interpolation processes of the fractional-pel pixels f_{0,0}, j_{0,0}, and q_{0,0} are as follows: using the 8-tap interpolation filter on the adjacent integer-pel pixels in the horizontal direction, and using the interpolation filter coefficient corresponding to the 2/4-pel position, whereby acquiring an intermediate value b′_{0,i} (i ranges from between −3 and 4); using the 6-tap interpolation filter on the intermediate value b′_{0,i} in the vertical direction, and using the interpolation filter coefficients corresponding to 1/4-pel, 2/4-pel, and 3/4-pel positions, respectively, whereby acquiring corresponding fractional-pel pixels f_{0,0}, j_{0,0}, and q_{0,0}; and calculation equations are as follows:
f_{0,0}=(2×b′_{0,-2}−9×b′_{0,-1}+57×b′_{0,0}+17×b′_{0,1}−4×b′_{0,2}+b′_{0,3})>>shift2
j_{0,0}=(2×b′_{0,-2}−9×b′_{0,-1}+39×b′_{0,0}+39×b′_{0,1}−9×b′_{0,2}+2×b′_{0,3})>>shift2
q_{0,0}=(b′_{0,-2}−4×b′_{0,-1}+17×b′_{0,0}+57×b′_{0,1}−9×b′_{0,2}+2×b′_{0,3})>>shift2

6. The method of claim 1, wherein
interpolation processes of the fractional-pel pixels g_{0,0}, k_{0,0}, and r_{0,0} are as follows: using the 8-tap interpolation filter on the adjacent integer-pel pixels in the horizontal direction, and using the interpolation filter coefficient corresponding to the 3/4-pel position, whereby acquiring an intermediate value c′_{0,i} (i ranges from between −3 and 4); using the 6-tap interpolation filter on the intermediate value c′_{0,i} in the vertical direction, and using the interpolation filter coefficients corresponding to 1/4-pel, 2/4-pel, and 3/4-pel positions, respectively, whereby acquiring corresponding fractional-pel pixels g_{0,0}, k_{0,0}, and r_{0,0}; and calculation equations are as follows:
g_{0,0}=(2×c′_{0,-2}−9×c′_{0,-1}+57×c′_{0,0}+17×c′_{0,1}−4×c′_{0,2}+c′_{0,3})>>shift2
k_{0,0}=(2×c′_{0,-2}−9×c′_{0,-1}+39×c′_{0,0}+39×c′_{0,1}−9×c′_{0,2}+2×c′_{0,3})>>shift2
r_{0,0}=(c′_{0,-2}−4×c′_{0,-1}+17×c′_{0,0}+57×c′_{0,1}−9×c′_{0,2}+2×c′_{0,3})>>shift2

7. The method of claim 2, wherein shift1 equals 6.

8. The method of claim 3, wherein shift1 equals 6.

9. The method of claim 2, wherein shift2 equals 12.

10. The method of claim 3, wherein shift2 equals 12.

11. A fractional-pel interpolation filter device using the method of claim 1 for achieving video image processing.

12. An electronic data carrier stored with a computer program comprising the method of claim 1.

13. An electronic device using the method of claim 1 for processing a video image.
